(19) United States
(12) Patent Application Publication
(10) Pub. No.: US 2023/0380439 A1
(43) Pub. Date: Nov. 30, 2023

(54) READY TO EAT CHEWABLE COFFEE TABLETS

(71) Applicant: Bug Eyed Ltd., Colorado Springs, CO (US)

(72) Inventor: Por-ngam MURPHY, Colorado Springs, CO (US)

(21) Appl. No.: 18/323,110

(22) Filed: May 24, 2023

Related U.S. Application Data
(60) Provisional application No. 63/365,238, filed on May 24, 2022.

(30) Foreign Application Priority Data
Jul. 1, 2022 (TH) 2201004181

(51) Int. Cl. A23F 5/38; A23F 3/32; A23F 5/14; A23G 1/00

(52) U.S. Cl. CPC A23F 5/385; A23F 3/32; A23F 2200/00; A23G 1/0016; A23F 5/14

(57) ABSTRACT

The present disclosure relates to a solid coffee product for oral administration or dissolution whose preparation comprises, roasting the coffee beans, grinding the coffee beans into a granular form, charging dissolvent for extraction, extracting the available composition, filtering to remove coffee dross, spray-drying or freeze-drying the coffee extract, charging flavorings, mixing homogeneously, palletizing, drying, pressing into solid coffee product of various shapes, suitable for oral administration, through mechanical means.

This application claims priority to U.S. Ser. No. 63/365,238, filed May 24, 2022, and Thai Patent Application No. 2201004181, filed Jul. 1, 2022, the contents of which are herein incorporated by reference. The present teaching generally relates to coffee extract tablet and a preparation method thereof. More specifically, the present teaching is directed to a ready to eat coffee tablet and preparation method thereof.

### I. BACKGROUND

Coffee is enjoyed by millions of people around the world every day. Coffee naturally contains a variety of compounds including caffeine, antioxidants, and diterpenes. These contribute not only to the unique flavor but also to the well-researched health and physiological effects of coffee.

Caffeine is a major pharmacologically active compound in coffee, and it is a mild central nervous system stimulant. Caffeine is found is some 60 plant species worldwide.

Extensive research has shown that there are several beneficial effects of caffeine in the diet, such as improved attention, alertness, and physical performance. However, some individuals experience adverse effects, such as disturbed sleep patterns.

The sensory experience when consuming a cup of coffee is one of the key aspects of the drink, providing unique aromas, tastes, and flavors. However, coffee is typically associated with bitterness.

To combat the bitterness of coffee, creamer is usually added to make coffee delightful and sweet. Most creamers do not contain any cream. While this may be good news for those that are lactose intolerant, it often means the products are full of sugar, oil, and thickeners. The oils are often partially hydrogenated, making it an unhealthy trans fat to consume daily. Consuming a lot of trans fat raises a person's chances of having bad cholesterol that can raise the risk of developing heart disease or stroke.

### II. SUMMARY

It is still desirable, however, to provide a ready to eat coffee tablet and preparation method that does not require dissolution into water.

The present teaching makes it quite easy to consume caffeine to fight the effects of fatigue and drowsiness and provide the sensory experience associated with consuming coffee.

The present teaching offers a healthier alternative to consuming coffee.

Still other benefits and advantages of the present subject matter will become apparent to those skilled in the art to which it pertains upon a reading and understanding of the following detailed specification.

### III. BRIEF DESCRIPTION OF THE DRAWINGS

The present teaching may take physical form in certain parts and arrangement of parts, aspects of which will be described in detail in this specification and illustrated in the accompanying drawings which form a part hereof and wherein:

FIG. 1 is a flow chart detailing an aspect of the preparation method for ready to eat coffee tablets and the like.

### IV. DETAILED DESCRIPTION

Referring now to the drawings wherein the showings are for purposes of illustrating aspects of the present teaching only and not for purposes of limiting the same, and wherein like reference numerals are understood to refer to like components.

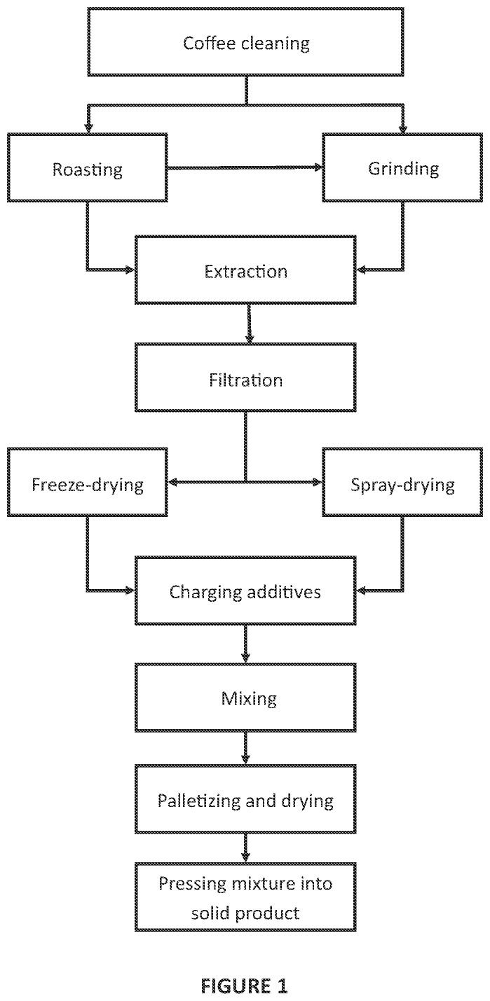

With reference now to FIG. 1, a manufacturer will go through the following nine step process: coffee cleaning/preprocessing, roasting and/or grinding, extraction, filtration, freeze-drying or spray drying, charging additives, mixing, palletizing, drying, and pressing the mixture into a solid product ready for packaging.

In one aspect of the present teaching, a ready to eat coffee tablet comprises, but is not limited to, from about 1 to about 50 weight percent coffee, from about 5 to about 99 weight percent coconut milk powder, from about 0 to about 50 weight percent milk, from about 0 to about weight percent non dairy creamer, from about 0 to about 40 weight percent sugar, from about to about 40 weight percent sugar substitute, from about 0 to about 10 weight percent color additive, from about 0 to about 10 weight percent flavor additive, from about 0 to about 10 weight percent scent additive, and from about 0 to about 10 weight percent stabilizing agent. In one aspect of the present teaching, the table has about 2 mg of caffeine per tablet.

In another aspect of the present teaching, a ready to eat coffee tablet comprises, but is not limited to, from about 1 to about 50 weight percent coffee, from about 5 to about 99 weight percent coconut milk powder, from about 0 to about 60 percent coconut powder, from about 0 to about 50 weight percent milk, from about 0 to about 50 weight percent non-dairy creamer, from about 0 to about 40 weight percent sugar, from about 0 to about 40 weight percent sugar substitute, from about 0 to about 10 weight percent color additive, from about 0 to about 10 weight percent flavor additive, from about 0 to about 10 weight percent scent additive, from about 0 to about 10 weight percent stabilizing agent, from about 0 to about 50 weight percent of at least one of the following: tea, cocoa, chocolate, cow milk, goat milk, rice milk, soy milk, marijuana powder, hemp powder, kratom powder, caramel powder, vanilla powder, mint powder, lime powder, lemon powder, cinnamon powder, fruit powder, vegetable powder, grain powder, and herb powder, and about 0 to about 20 weight percent vitamin, mineral salt, and caffeine.

In another aspect of the present teaching, the ready to eat coffee tablet about 1 to about 50 percent coffee and about 5 to about 99 coconut powder or coconut milk powder. In another aspect, the coffee extract can be from about 1 to about 30 percent and the coconut powder or coconut milk powder can be about 70 to about 99%. In another aspect of the present teaching, the tablet contains no trans fat.

In another aspect of the present teaching, the ready to eat tablet can be made of a flavor ingredient, wherein the flavor ingredient can be chosen from coffee, tea, cocoa, or chocolate, or combinations thereof. Added to the flavor ingredient is the coconut powder or coconut milk powder, or a combination thereof. Next, another ingredient can be added, chosen from cow milk, goat milk, rice milk, soy milk, non-dairy creamer, or combinations thereof. In addition, an optional sweetener can be added. Examples of sweeteners are sugar and sugar substitutes. To these, other optional ingredients can be chosen from marijuana powder, hemp powder, kratom powder, caramel powder, vanilla powder, mint powder, lime power, lemon powder, cinnamon powder, fruit powder, vegetable powder, herb powder, grain powder, or combinations thereof. Additionally, a stabilizing agent can be added. Another additional ingredient can be chosen from color, scent, flavor, and combinations thereof. In another aspect, the method begins with the provision of freeze-dried or spray-dried coffee extract and coconut milk powder. The ingredients are mixed together and pressed into tablet form, and then packaged. In another aspect of the present teaching, the composition can be in a powder form, a liquid form, or a liquid gel capsule.

Clause 1—A coffee tablet including a coffee extract, at least a first coconut powder, a milk powder, at least a first non-dairy creamer, a sugar, at least a first coloring agent, a stabilizing agent, wherein the coffee extract is spray-dried or freeze-dried.

Clause 2—The coffee tablet of clause 1, wherein the coconut milk powder can be substituted for coconut powder.

Clause 3—The coffee table to clause 1 or 2, wherein the sugar can be a sugar substitute.

Clause 4—A method for producing a coffee tablet, the method including roasting raw coffee beans, grinding the coffee beans into a granular form, charging dissolvent for extraction, extracting the available composition, filtering to remove coffee dross, spray-drying or freeze drying the coffee extract, charging flavorings, mixing homogeneously, palletizing, drying, and pressing into solid coffee product of various shapes.

Clause 5—A coffee tablet comprising a coffee extract and coconut powder or coconut milk powder.

Clause 6—The tablet of clause 5, wherein the coffee extract is about 1% to about 30% by weight.

Clause 7—The tablet of clauses 5 or 6, wherein the coconut powder or coconut milk powder is about 70% to about 99% by weight.

Claus 8—A method for producing a coffee tablet including providing a free-dried or spray-dried coffee extract, mixing the coffee extract with coconut milk powder, and compressing the mixture into tablets.

Numerous aspects have been described herein. It will be apparent to those skilled in the art that the above methods and apparatuses may incorporate changes and modifications without departing from the general scope of the present teaching. It is intended to include all such modifications and alterations in so far as they come within the scope of the appended claims or the equivalents thereof. The right to claim elements and/or sub-combinations that are disclosed herein is hereby unconditionally reserved.

Having thus described the present teaching, it is now claimed:

I/We claim:

1. A ready to eat tablet comprising:
a flavor ingredient, wherein the flavor ingredient can be chosen from coffee, tea, cocoa, or chocolate, or combinations thereof; and
coconut milk powder or coconut powder.

2. The tablet of claim 1, wherein the tablet further comprises:
a sweetener; and
a stabilizing agent.

3. The tablet of claim 2, wherein the tablet further comprises:
non-dairy creamer; and
milk powder.

4. The tablet of claim 3, where in the tablet further comprises:
at least one food coloring agent.

5. The tablet of claim 1, wherein the flavor ingredient is an extract that is spray dried or freeze dried.

6. The tablet of claim 1, wherein the flavor ingredient is a coffee extract, wherein the table contains no trans fats.

7. The tablet of claim 6, wherein the coffee extract is between about 1 percent to about 50 percent coffee and the coconut powder or coconut milk powder is between about 5 percent to about 99 percent.

8. The tablet of claim 7, wherein the coffee extract is between about 1 percent to about 30 percent and the coconut powder or coconut milk powder is between about 70 percent to about 99 percent.

9. The tablet of claim 4, wherein the flavor ingredient is between about 1 weight percent and about 50 weight percent, the coconut milk powder is about 5 weight percent and about 99 weight percent, the coconut powder is between about 0 weight percent and about weight percent, the milk powder is between about 0 weight percent and about 50 weight percent, the non-dairy creamer is between about 0 weight percent and about 50 weight percent, the sweetener is between about 0 weight percent and about 40 weight percent, and the at least one food coloring agent is between about 0 weight percent and about 10 weight percent.

10. The tablet of claim 9, wherein the tablet further comprises:
about 0 weight percent to about 10 weight percent flavor additive;
about 0 weight percent to about 10 weight percent scent additive;
about 0 weight percent to about 10 weight percent stabilizing agent;
about 0 weight percent to about 50 weight percent of at least one of the group consisting of tea, cocoa, chocolate, cow milk, goat milk, rice milk, soy milk, marijuana powder, hemp powder, kratom powder, caramel powder, vanilla powder, mint powder, lime powder, lemon powder, cinnamon powder, fruit powder, vegetable powder, grain powder, and herb powder; and
about 0 weight percent to about 20 weight percent of at least one of the group consisting of vitamin, mineral salt, and caffeine.

11. A method for producing an edible coffee tablet, the method comprising the steps of:
roasting raw coffee beans;
grinding the coffee beans into a granular form;
charging dissolvent for extraction;
extracting a coffee extract;
filtering to remove coffee dross;
spray-drying or freeze drying the coffee extract;
charging flavorings;
mixing homogeneously;
palletizing;
drying; and,
pressing into solid coffee product of various shapes.

12. The method of claim 11, wherein the tablet further comprises:
coconut powder or coconut milk powder;
a sweetener; and
a stabilizing agent.

13. The method of claim 12, wherein the tablet further comprises:
non-dairy creamer; and
milk powder.

14. The method of claim 13, where in the tablet further comprises:
at least one food coloring agent.

15. The method of claim 12, wherein the coffee extract is between about 1 percent to about 50 percent coffee and the coconut powder or coconut milk powder is between about 5 percent to about 99 percent.

16. The method of claim 15, wherein the coffee extract is between about 1 percent to about 30 percent and the coconut powder or coconut milk powder is between about 70 percent to about 99 percent.

17. The method of claim 16, wherein the flavor ingredient is between about 1 weight percent and about 50 weight percent, the coconut milk powder is about 5 weight percent and about 99 weight percent, the coconut powder is between about 0 weight percent and about weight percent, the milk powder is between about 0 weight percent and about 50 weight percent, the non-dairy creamer is between about 0 weight percent and about 50 weight percent, the sweetener is between about 0 weight percent and about 40 weight percent, and the at least one food coloring agent is between about 0 weight percent and about 10 weight percent.

18. The method of claim 17, wherein the tablet further comprises:
about 0 weight percent to about 10 weight percent flavor additive;
about 0 weight percent to about 10 weight percent scent additive;
about 0 weight percent to about 10 weight percent stabilizing agent;
about 0 weight percent to about 50 weight percent of at least one of the group consisting of tea, cocoa, chocolate, cow milk, goat milk, rice milk, soy milk, marijuana powder, hemp powder, kratom powder, caramel powder, vanilla powder, mint powder, lime powder, lemon powder, cinnamon powder, fruit powder, vegetable powder, grain powder, and herb powder; and about 0 weight percent to about 20 weight percent of at least one of the group consisting of vitamin, mineral salt, and caffeine.

19. A method for producing an edible tablet, the method comprising the steps of:
providing a free-dried or spray-dried flavor ingredient, wherein the flavor ingredient can be chosen from coffee, tea, cocoa, or chocolate, or combinations thereof;
mixing the flavor ingredient with coconut milk powder; and
compressing the mixture into tablets.

20. The method of claim 19, wherein the tablet contains no trans fats.
